(19) United States
(12) Patent Application Publication
(10) Pub. No.: US 2005/0201757 A1
(43) Pub. Date: Sep. 15, 2005

(54) Method and arrangement for determining signal degradations in the presence of signal distortions

(76) Inventors: Marc Bohn, Munchen (DE); Richard Neuhauser, Neufahm (DE); Marc-Steffen Wrage, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/102,934

(22) Filed: Apr. 7, 2005

(30) Foreign Application Priority Data
Oct. 8, 2002 (DE) 10246723.4

(51) Int. Cl. H04B 10/12

(52) U.S. Cl. 398/149

(57) ABSTRACT

The invention relates to a method and several arrangements for determining signal degradations of an optical signal transmitted in a transmission signal in the presence of signal distortions, wherein at least one part of the optical signal is fed to an adaptive optimal or electric filter at a place of measurement in the transmission system and is subsequently measured according to one or several quality parameters. A first measurement of the quality parameter is carried out by transparent adjustment of the adaptive filter and other measurements of the quality parameters are carried out with redefined transparency properties of the adaptive optical filter which respectively have an influence upon signal distortions. As a result it is possible to analyze or to separate signal-influencing effects or groups of effects. In another embodiment of the invention, the filter parameters of an optical/electric equalizer or filter structure, which are adjusted by said analysis, are described according to optimization of the signal quality.

### CROSS REFERENCE TO RELATED APPLICATIONS

This application is a continuation application of US National Stage Application applicants docket no. 2002P15650WOUS, filed on Apr. 7, 2005 and claims the benefits of the US National Stage Application. The US National Stage Application claims the benefits of International Application No. PCT/DE2003/002941, filed Sep. 4, 2003. The International Application claims the benefits of German application No. 10246723.4 filed Oct. 8, 2002, all three applications are incorporated by reference herein in their entirety.

### FIELD OF THE INVENTION

The invention relates to a method and an arrangement for determining signal degradations in the presence of signal distortions.

### SUMMARY OF THE INVENTION

Determination of the optical signal quality and the reasons for signal interference, preferably in the next generation of WDM networks (WDM=wavelength division multiplex), is of great importance for the operation of optical networks. Thus, for example, the qualities of the individual channels must be measured in a WDM signal which is transmitted, in order to control a so-called pre-emphasis or a tipping, as applicable, of the power level of the optical channels, and thus to optimize the system performance. For the purpose of problem avoidance and elimination, faults which arise must be localized and their cause quickly determined. The object of determining the signal quality and the causes of faults is a central and as-yet unsolved problem for the next generation of optical networks.

One method currently used for determining the signal quality is the measurement of the optical signal-to-noise ratio (OSNR) using an optical spectrum analyzer (OSA). For this purpose, the ratio of the signal power to the noise signal level is calculated on one side of and close to the signal frequency for the channel. The implicit assumption here is that the noise levels at and directly alongside the signal wavelength for the channel are the same

However, with this method several problems arise immediately.

When optical filters (e.g. multiplexers or demultiplexers, interleavers, single-channel filters) are used in “optical add-drop multiplexers”, OADMs, or “optical crossconnects”, OXCs, such as are increasingly found in today's systems, it is no longer permissible to assume that the measured noise levels beside and at the signal wavelength are equal. This is also the case if a too-small wavelength spacing between neighboring channels leads to an overlap of the signal edges. Furthermore, the measurement results can be falsified by spectral broadening, e.g. by self-phase-modulation, SPM, cross-phase-modulation, XPM, or an excessively high transmission rate in the case of signals with “forward error correction”, FEC.

The method currently used for measuring the signal-to-noise ratio, OSNR, by means of optical spectrum analysis also fails to detect the-degradations in the signal which can be caused either by non-linear effects such as stimulated Raman scattering, SRS, four wave mixing, FWM, or by crosstalk or dispersion, GVD, as applicable. Effects such as, for example, self-phase-modulation, SPM or cross-phase-modulation, XPM, are incorrectly interpreted as a deterioration in the OSNR.

One alternative method for determining the OSNR exploits the different polarization characteristics of signal and amplifier noise (ASE). This method (“polarization nulling”) is based on a determination of the relationship between the polarized signal and the unpolarized noise.

For the reasons set out above, a determination of the signal quality using a measured optical spectrum is no longer adequate for optical data transmission systems. Other methods are a significantly more informative about the signal quality. One example which should be mentioned here is the Q-measurement method, with which the discrimination threshold of a second discriminator is displaced relative to the discrimination threshold of the reference discriminator. If one plots the bit error rate against the detuned discriminator threshold one can, if one assumes Gaussian noise, determine the optimal bit error rate. In addition, with a known bit sequence one can determine the bit error rate by a direct comparison between the transmitted and received bit patterns. In the case of systems with “forward error correction”, FEC, or “enhanced forward error correction”, EFEC, reference can be made to the corrected bits as a measure of the signal quality.

When recording eye patterns for the purpose of determining the signal quality, a fast photodiode is used to sample synchronously the power level of the optical signal, or one of its channels. A variable delay line ensures that it is possible to make measurements not only at the center of the bit but also to the left and right of it. In this way, one obtains the overlaps in the power level graphs of many bits in a single diagram. The larger is the internal opening, the so-called eye, the better can a discriminator in the receiver distinguish between the “zeros” and “ones” which are transmitted, and the more error-free is the signal transmission. In the case of EAS (electrical amplitude sampling), the frequency distribution of the amplitude values is measured for the “zeros” and “ones” which are received, and from this the signal quality is determined. In the synchronous case, this always occurs at a fixed sampling time point. This is generally in the center of the bit.

Statements as to the signal quality can be obtained on the basis of measured amplitude histograms, from the width and position of the maxima or, on the eye diagram, from the opening of the eye. When there is interference due to noise or noise-like effects, the distributions of the “zeros” and the “ones” widen out in the amplitude histogram, and the blank area in the eye diagram gets smaller. Signal deteriorations due to noise effects cannot be compensated for.

However, the mere-determination of the signal quality is not sufficient for the purpose of recognizing the causes of errors. Statements are required as to the origin of any signal deterioration. In future optical transmission networks, signal channels from different sources will be brought together at node points, as in the case of the OADMs or OXCs already mentioned, and transmitted onward via a common fiber. As the various channels will have different histories in respect of the signal deteriorations they have suffered, the signal channels cannot be considered in their totality in order to determine a source of interference. Instead, it is logical to extract information, about the quality and possible reasons for interference on a data channel, directly from measurements carried out on the channel under consideration. It is proposed that an adaptive optical filter is used for minimizing the signal distortions. An arrangement which permits equalization of an optical signal for dispersion, GVD, self-phase-modulation, SPM, and polarization mode dispersion, PDM, by means of an adjustment to the pass characteristics of an adaptive optical filter, is disclosed in “An Adaptive Optical Equalizer Concept for Single Channel Distortion Compensation”, M. Bohn et al., ECOC 2001, Amsterdam, MO.F.2.3. Using simulations, the eye opening of the measured distorted signal, after it has been allowed past into the adaptive optical filter in the form of an FIR filter (FIR=finite impulse response), is calculated up to the 10^{th} order, and for different bandwidths, FSR (free spectral range) for the purpose of phase delay. By an appropriate adjustment of the adaptive optical filter it is shown that effective compensation of the signal distortions, to level out the signal quality of a channel, is achieved.

Furthermore, signal distortions can be detected by a determination and analysis of the electrical spectrum of the digital data signals. In laboratory experiments, such analyses are also used for controlling electrical equalizers and/or compensators, for improving signals. Although analysis of the electrical spectrum does allow automated signal optimization, it does not generally permit any distortion-specific statements. In addition, the electrical spectrum is strongly dependent on the transmitter, and hence is also unsuitable for detecting distortions in data transmission systems.

Some distortions can also be detected and investigated individually. Thus, for example, chromatic dispersion can be measured using variable dispersion compensation followed by a signal quality analyzer. Such solutions are technically demanding and expensive. Furthermore, in each case they detect only the type of distortion under investigation, but not a general signal distortion. The use of individual distortion detection for fast and comprehensive distortion detection is very demanding, and hence not the optimal approach.

Because of their complexity and costs, because of the need for on-site experts or because of their severe restrictions in terms of their informativeness, current measurement methods are thus not suitable for commercial use in monitoring data networks. A simple general statement that signal distortions are present, which would be extremely useful to network operators, cannot currently be made.

The object of the invention is to specify a method and corresponding arrangements with which statements can be supplied, for example using an adaptive optical filter, about the main causes of signal degradations and the signal quality of a transmitted optical signal. It is also to specify a solution, by which the statements indicated above can be made, if components other than the adaptive optical filter cited above are used—e.g. an electrical or optical equalizer, an electrical or optical compensator, etc.

This object is achieved by the claims.

In accordance with the invention predefined pass characteristics, each of which has an influence on one or more signal distortions, are set in a first way for the adaptive optical filter.

At the output from the adaptive optical filter, one or more measurements are made on one or more quality parameters. This enables a statement to be made as to which of the main effects, which can influence the signal, are degrading the measured signal. Here, a distinction is made between deterministic signal distortions and noise-like interference. The adaptive filter can only influence deterministic signal distortions, i.e. it can for example compensate out all distortions or dispersion alone. Furthermore, compensations can be applied to the optical signal by optimized settings of the adaptive optical filter. This matter has already been explained in the state of the art. Nevertheless, on the basis of the exclusion principle it can also be used to make statements about the noise-like interference. For example, if the signal-to-noise ratio, OSNR, is measured additionally after the adaptive optical filter (e.g. using polarization nulling or with an optical spectrum analyzer or by amplitude sampling) then it is likewise possible to distinguish various forms of noise-like interference (e.g. ASE, FWM, XPM, etc.).

Further quality parameters—possibly in combination—can be used. The main point is that the selected quality parameter supplies a statement about signal distortions or about noise-like interference, or about both.

In the case of broadband optical signals, such as in typical WDM transmission systems, a part of the spectrum, for example at a channel wavelength, is isolated before the signal is fed into the adaptive optical filter. It is advantageous if the only connection downstream from the adaptive optical filter is to a fast photodiode with a downstream module for measuring the quality parameter. The photodiode can also be integrated into the module for measuring the quality parameter. Several values of the quality parameter are saved for different settings of the adaptive optical filter's pass characteristics, and are compared with the value of the quality parameter when the adaptive optical filter allows everything to pass. By doing so, one obtains a measure of the degradation of the optical signal in terms of signal interference. The use of the adaptive filter in the optical domain is advantageous because the influence is exerted on the signal even before the photodiode (and thus before the loss of phase information), and individual effects can thus be more easily determined.

The settings selected for the pass characteristics of the adaptive optical filter can at one and the same time have an effect jointly on more than one signal distortion. For this reason groups of measurements are also considered, for different settings, so that unambiguous statements can be provided about one or more signal distortions. After the signal distortions have been determined, it is possible in addition to make a statement about the residual noise components (e.g. amplifier noise) or other forms of interference (FWM=four wave mixing, SRS, etc.). As an optional addition for this purpose, an optical spectrum analyzer or a further suitable quality measurement device can be connected to the adaptive optical filter.

As already mentioned for the state of the art, interference due to various causes can lead to the eye diagram being distorted in different ways. To obtain an eye-shape as near as possible to the optimum, one-or more adjustment parameters of an electrical equalizer or compensator, as applicable, are adjusted in accordance with the form of distortion. An electrical equalizer can be realized as a FIR or IIR filter with several adjustment parameters, to which is fed the opto-electrically converted signal, and at the output from which the shape of the eye diagram which is determined can be correspondingly modified by varying the adjustment parameters. The adjustable equalizer or filter coefficients, as applicable, to be used as adjustment parameters for the filter mentioned above, are intended as weighted sums of different phase- or time-delayed signals of the distorted or filtered signal, as applicable. Here, different signal distortions are expressed as various filter coefficient vectors which can, for example, be analyzed in conjunction with the signal quality of the equalized or filtered signal. Conversely, it is possible in a simple manner to derive statements about the signal distortions, present in the signal which is to be equalized, by determining these filter coefficients, for example in the form of a coefficient vector. Predefined coefficient vectors can be used for selective conclusions. This advantageous method can be used, when the coefficient vectors characteristic of different types of distortion are known, to effect a rapid assignment, for example tabular, of the filter parameter settings to the corresponding causes of interference.

This method can also be applied when the above-mentioned optical adaptive filter is used, or another optical compensator (e.g. a dispersion compensator), with their associated adjustment parameters.

The invention thus proposes that one or more series of adjustment coefficients set for an equalizer or a filter, as applicable, are analyzed in the case of the signal quality which arises to obtain information about the causes of signal distortion. On the assumption that the signal quality is, for example, optimized by the electrical equalizer, the adjustment coefficients must contain information about the signal interference which has been equalized. If the structure of the equalizer or filter, as applicable, is known the adjustment coefficients can be appropriately analyzed. However, even without a precise knowledge of the filter structure, the filter coefficients can be interpreted and analyzed with the aid of selective reference measurements which provide an indication of how the filter coefficients are set for particular signal distortions.

With this method, the electrical equalizer or a compensator or the optical adaptive filter previously used need not necessarily be set to predefined values. In this case, the analysis of signal quality is not carried out by exercising selective influence on the optical or electrical signal by means of an optical or electrical adaptive filter followed by a signal quality analysis. Instead, a one-off setting is made to the adaptive filter such that the signal quality achieves an optimum, in order then to determine the signal interference from an analysis of the filter coefficients or their values, as appropriate, at the optimum and/or up to it. As a criterion for optimal signal quality reference can be made, for example, to the eye height, shape or size of the filtered or equalized eye diagram which is determined, or to the numbers of FEC corrected bits.

When electrical equalizers or compensators are used for determining signal degradations in the presence of signal distortions, several important advantages should be noted. First, as a basic technology these components are commercially available from a wide choice of products. The realization of an arrangement of this type in accordance with the invention is thus simple and economical. They can always be used, regardless of the type of receiver or transmission system, or the supplier.

The filter coefficients can be directly supplied or obtained from the electrical equalizers or compensators. Hence, no additional electronic unit is required for the determination of the filter coefficients.

Electrical equalizers offer a very short setting time and can, for example, be set or regulated within a few thousand bits, i.e. in less than 1 μs at 10 Gb/sec. The method in accordance with the invention thus has a high speed.

Optical compensators are, in particular, broadly independent of the transmission rate and the modulation format used for an optical signal. This consideration applies also, to a restricted extent, to electrical equalizers which have a frequency tolerance of about 20-30% at the transmission rate.

Depending on the setting requirements applicable for the filter coefficients, the determination of signal distortions can range from qualitative to quantitative.

These methods can be applied at any measurement point in the transmission system, e.g. at an add-drop device using a tapping-off device. The results supplied can be analyzed, for example, via the network management facilities so that, for example, the transmission characteristics can be changed selectively for channels. Alternatively, it is also possible to use a simple portable computation unit, such as a normal computer. Using this it is also possible to carry out the measurement and analysis of signal degradations at any arbitrary measurement point, by tapping-off the signal or by the use of a monitoring channel.

A suitable arrangement using the optical adaptive filter is presented, in which a single- or two-stage amplifier is used to match the measured signal to the measurement dynamics.

A further more cost-effective arrangement using the optical adaptive filter is also presented,

In addition, further arrangements are presented, in which an electrical equalizer or compensator is provided as the filter, for which the determination of signal degradations in the presence of signal distortions, by reference to filter coefficients, is described in detail.

Advantageous developments of the invention are specified in the dependent claims.

### BRIEF DESCRIPTION OF THE DRAWINGS

An exemplary embodiment of the invention is explained in more detail below, with reference to the drawing, in which;

FIG. 1 shows a basic arrangement for performing the method in accordance with the invention,

FIG. 2 shows a detailed arrangement for performing the method in accordance with the invention,

FIG. 3 shows a cost-effective arrangement for performing the method in accordance with the invention,

FIG. 4 shows another arrangement, with an electrical equalizer,

FIG. 5 shows an alternative arrangement with an optical compensator,

FIG. 6 shows a representation of the adjustment setting space for filter coefficients,

FIG. 7 shows an adjustment series for the complex filter coefficients,

FIG. 8 shows an adjustment series for the magnitudes of the complex filter coefficients,

FIG. 9 shows a characterization of the optical or electrical filter's transmission function.

### DETAILED DESCRIPTION OF THE INVENTION

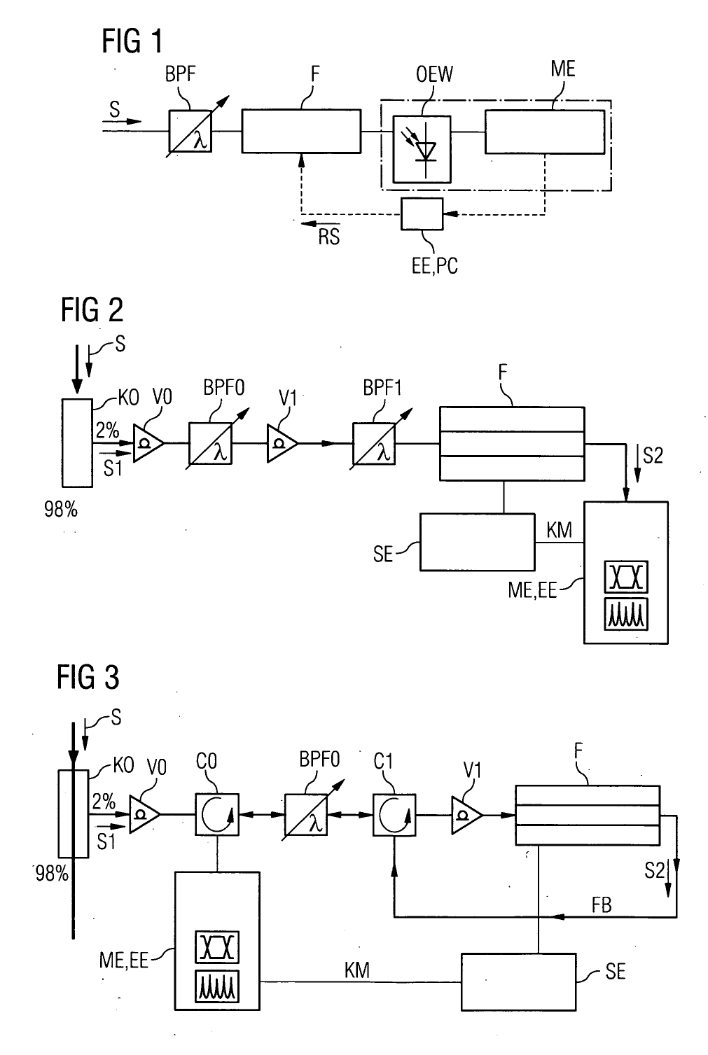

FIG. 1 describes a basic arrangement which permits a determination of signal degradations or distortions, as applicable, for an optical signal S transmitted in a transmission system. At a measurement point in the transmission system, a fraction of the optical signal S is fed to an adaptive optical filter F, and is then measured from a measurement unit ME according to a quality parameter. For the measurement unit, use is made for example of an electrical spectrum analyzer or a power meter on a bandpass filter BPF, in circuit before the adaptive optical filter F for the purpose of isolating one optical channel wavelength. For this purpose, an opto-electric converter OEW is connected between the adaptive optical filter F and the measurement unit. However, the opto-electric converter OEW is in practice often integrated into the measurement unit ME). Here, a fast photo-diode is used. The use of the adaptive filter F in the optical domain is advantageous because it exerts its influence on the signal even before the photo-diode OEW (and hence before the loss of phase information), and thus individual effects can be more easily determined. Connected after the measurement unit ME is a unit EE for determining the signal quality by at least one quality parameter such as OSNR, bit error rate, Q factor or a number of corrected bits in the case of FEC/EFEC, or for the measurement of polarization effects. The chosen quality parameter or the measurement unit EE, as applicable, provides in particular a statement as to the signal distortions, and in addition about residual noise-like interference such as the OSNR. In this exemplary embodiment, the determination unit is integrated into a computer, PC, which also controls the settings of the adaptive optical filter F by means of a control signal RS. The settings can also be controlled directly by network management facilities.

According to the method, a first measurement M0 of the quality parameter(s) is made with the adaptive optical filter set to pass all. A bypass circuit may also be used to allow the signal through in full. Further measurements M1, M2, . . . of the quality parameter are made with various settings for the pass characteristics of the adaptive optical filter F which are predefined in the computer PC, each of which has an influence on one of the signal distortions and from which an optimum is determined for the quality parameter.

For the measurement M1, the adaptive optical filter F can, for example, be set to various dispersion values. The signal quality is measured as a function of the dispersion and one obtains the optimal dispersion compensation setting together with the signal quality at the optimal dispersion compensation setting. In this way, the real signal quality can be determined at any desired point in the optical transmission system, independently of the cumulative dispersion. In addition, the dispersion tolerance at this point can be determined, this being a measure of how precisely the residual dispersion must be adjusted in order to achieve a given bit error rate.

For the measurement M2, the signal quality is optimized using the adaptive optical filter F. All the distortion effects are influenced or compensated by this adjustment, independently of their cause. In this way, one obtains the best possible signal quality after the signal has been equalized. Only noise-like interference such as, for example, amplifier noise, FWM or SRS, will now still result in a deterioration in the signal. Further, it is possible to compensate selectively for distortions due solely, for example, to SPM. In this way, one obtains statements as to which interference effect influences the signal in which way.

Using this method it is possible to decide, for example by a comparison of the signal quality measured for the three settings mentioned of the adaptive optical filter F and by the corresponding measurements M0, M1, M2, whether a signal deterioration has been caused by dispersion, other distortions or by noise-like effects. The determination of the signal quality at the optimal dispersion compensation permits a reliable statement of the signal quality at the measurement point, and about the status of the dispersion compensation. Further, the influence of various filter settings on the results from the different measurement methods for signal quality analysis can be determined, and used as a criterion for making statements. If additional signal-to-noise ratios, OSNR, are measured it is possible, as already mentioned above, to distinguish noise-like effects. One or more quality parameters can also provide statements about polarization effects (e.g. PDL—polarization dependent loss, PDM—polarization mode dispersion, DGD—differential group delay, DOP—degree of polarization, etc.).

Because of the adaptive optical filter F, the actual signal quality can be measured, independently of the cumulative dispersion on a transmission link, at any network element in the transmission link. The dispersion leads to signal distortions which, in principle, can be cancelled out again by DCF (dispersion compensating fiber) or other methods of compensation. The signal quality on the channel can be measured as a function of different filter parameters, and makes signal and error analysis possible. The signal quality analysis can incorporate different methods, and even several methods simultaneously. Different forms of signal interference, such as dispersion, SPM or noise-like interference (amplifier noise, FWM, SRS, etc.) can be detected and distinguished.

As the various channels will have different histories in respect of the signal deteriorations they have suffered, it is now possible to deduce information about the cause of signal deteriorations from the channel-selective analysis of the total WDM signal S.

FIG. 2 describes an arrangement for the determination of signal degradations in an optical broadband signal S, transmitted via a transmission system, from which at least a fraction, S1, in spectral and/or amplitude terms is tapped off by means of a coupler KO and fed to an adaptive optical filter F. In this case, however, the spectral component of the signal S is selected by means of a bandpass filter BPF0 connected downstream from a broadband coupler KO. Connected downstream from the adaptive optical filter F are a measurement unit ME and a unit EE for the determination of one of more quality parameters. Connected to the adaptive optical filter F is a control unit SE for the purpose at least of switching through and/or to influence signal distortions, even as far as equalizing the optical signal S by the settings of predefined pass characteristics for the adaptive optical filter F.

Connected downstream from the coupler KO is a bandpass filter BPF0. By this, for example in the case of a multiplex signal S, one channel in the signal S is isolated and transmitted onward. Connected after the bandpass filter BPF0 is an amplifier V1, with a further bandpass filter BPF1 connected downstream from it. The amplifier V1 passes the amplified signal to the measurement dynamics of an opto-electrical converter, as shown in FIG. 1. The bandpass filter BPF1 also ensures that noise components comprising mainly ASE (amplified spontaneous emission) are suppressed. Optionally, an amplifier V1 may be inserted into the circuit between the coupler KO and the bandpass filter BPF0, as a booster for the signal fraction S1.

A control unit SE connected to the adaptive optical filter is used to control a module, which is integrated into the adaptive optical filter F, for influencing the phase and/or amplitude response of the optical signal. The filtered signal S2 at the output from the adaptive optical filter F is fed to the measurement unit ME. The quality measurement is then carried out as shown in FIG. 1, by means of the determination unit EE.

In addition, a communication facility KM between the control unit SE and the determination unit EE or the measurement unit ME, as applicable, is used on the one hand to supply a status for the setting of the adaptive optical filter F, either to the determination unit or to a further control unit, and on the other hand to carry out regulation of the adaptive optical filter F from the determination unit EE. For this reason it is best if the communication facility, KM, provided is directional.

In the determination unit or in the further control unit, a table can be created when the pass characteristics are reset, for use in registering the effects which can influence the signal against the corresponding setting of the pass characteristics of the adaptive optical filter F. This registration permits the effects which influence the signal to be analyzed or separated out for each setting of the pass characteristics of the adaptive optical filter F. Further, the pass characteristics of the adaptive optical filter F can be regulated in relation to one or a group of signal degradations, from an analysis of one of the quality parameters which have been determined. By using a predefined variation in the pass characteristics of the adaptive optical filter F, the signal quality can be analyzed or/and broken down in terms of different effects which influence the signal. Furthermore, the signal can be optimized in relation to one or more quality parameters by means of suitable adjustment parameters of the adaptive optical filter F, and from the adjustment parameters conclusions can be drawn about the signal degradations.

FIG. 3 shows an arrangement which, as in FIG. 2, is low cost, for measuring signal degradations for an optical broadband signal S transmitted over a transmission system, from which at least a fraction S1 in amplitude terms is extracted by means of a coupler KO and is fed to an adaptive optical filter F. Connected between the coupler KO and the adaptive optical filter F are a first circulator C0, followed by a bandpass filter BPF0, and then a second circulator C1. Connected to the output from the adaptive optical filter F is an optical signal feedback FB, for the purpose of transmitting the filtered signal S2 to the second circulator C1. The filtered signal S2 is supplied to a signal quality measurement unit ME as shown in FIG. 2 via the circulator C1, the bandpass filter BPF0 and the first circulator C0. Connected to the adaptive optical filter F is a control unit SE for the purpose at least of switching through and/or exercising an influence on signal distortions, even as far as equalizing the optical signal S. Connected between the bandpass filter BPF0 and the second circulator C1 is an amplifier V1. This amplifier V1 can also be arranged anywhere in the optical signal feedback FB, i.e. can be connected in circuit either before or after the adaptive optical filter F. Optionally, an amplifier V0 can be connected in circuit between the coupler KO and the first circulator C0 as a booster, as in FIG. 2.

The essential advantage of the arrangement shown in FIG. 3 consists in the fact that it saves one of the two bandpass filters BPF0, BPF1 shown in FIG. 2, and thus results in a reduction in costs.

The functionality and the other components ME, EE, KM, SE of this arrangement are identical with that shown in FIG. 1 or 2, as appropriate.

In both the arrangements, shown in FIG. 2 and 3, an opto-electrical converter is connected in circuit before the measurement unit ME.

Both arrangements can also be connected at the end of a transmission link or, for example, at the output from an add-drop module. This renders the coupler KO and the amplifier V0 superfluous.

The bandpass filters BP0, BPF1 or BPF0, as applicable, used as channel selectors are provided in the exemplary embodiments explained above as variable wavelength filters for use in allowing the selective passage of an optical channel when a wavelength multiplex technology is used. The use of suitable channel selectors enables the method in accordance with the invention to be applied for different multiplexing techniques (polarization multiplex, time-division multiplex etc.).

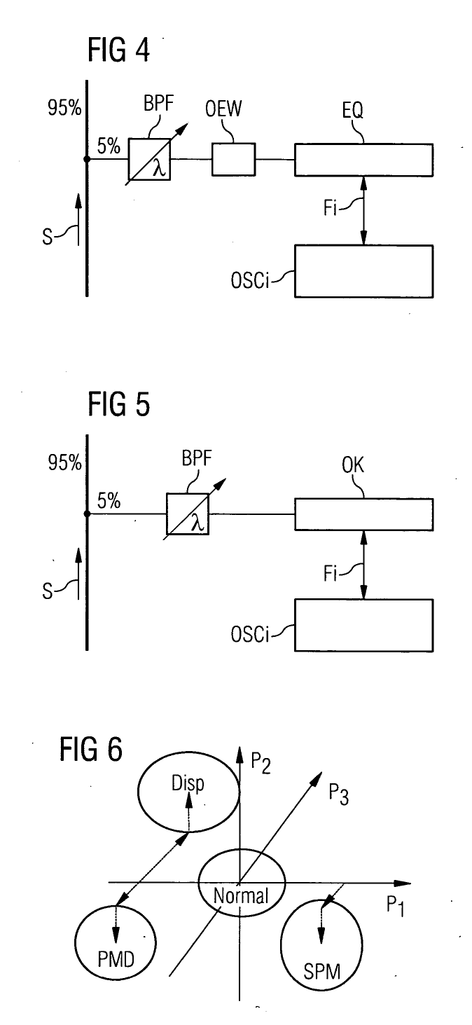

Next, FIG. 4 shows a further arrangement, for the determination of signal degradations in the presence of signal distortions in an optical WDM signal S diverted out of a transmission system, in which after the WDM signal S has passed through a wavelength-selective filter BPF the emergent signal is fed to an opto-electrical converter OEW, downstream from which is connected an electrical equalizer EQ. At the equalizer EQ, which is provided in the form of a FIR or IIR filter, various filter coefficients which are provided as adjustment parameters are set in accordance with the invention, and an eye diagram is produced, for example using an oscilloscope, for the purpose of analyzing the resulting signal quality. There are various ways in which the choice of the filter coefficients can be made. The signal quality can be optimized, for example in terms of the size of the eye, by one or more changes to the filter coefficients, and from this the resulting deviations of the filter coefficients analyzed in terms of the signal distortions. The changes to the filter coefficients can also be made using predefined values as test vectors, and also be reference to eye-specific requirements or characteristics. The filter coefficients can also be set on the basis of other signal quality parameters such as, for example, the bit error rate, Q value or the electrical spectrum. Here, the object of changing and analyzing the filter coefficients is to achieve a determination of the various distortions such as dispersion, phase mode dispersion, self-phase modulation, etc., which is as fast and automatic as possible. For the purpose of controlling a new setting of the filter coefficients, a computer or a microprocessor can be used as the control unit, with a unit for analysis of the equalized signal in conjunction with a series of filter coefficients supplying statements about the signal distortions which have been determined.

FIG. 5 shows an alternative to the arrangement shown in FIG. 4, with an optical compensator OK instead of the opto-electrical converter OEW and electrical equalizer EQ. In accordance with the invention, the adjustments are made and the analysis of the coefficients of the optical compensator OK carried out as in FIG. 4. This also applies exactly the same for an optical adaptive filter instead of the optical compensator.

FIG. 6 shows a diagram of a filter coefficient adjustment space in which, for the purpose of further analysis, the resulting filter coefficients can, for example, be interpreted as the components P1, P2, P3 of a vector. This vector is classified within the filter coefficient parameter space by its location, length and direction. Any one of the distortions, such as for example dispersion, polarization mode dispersion (PMD), or self-phase modulation (SPM), thus have neighboring coefficient vectors in a region of the parameter space. Conversely, because different setting vectors are used to equalize out different signal distortions, the different distortions and eye shapes are located in regions of the parameter space which are separate from one another. By assigning different areas within the control variable parameter space to individual causes of interference it is possible to determine the cause of distortion while in service by analyzing the current equalizer settings in each case. Here, the assignment of various signal distortions to different areas in the filter coefficient parameter space is shown for a three-dimensional coefficient space. Apart from a qualitative analysis, there may be further conclusions which can be drawn about the strength of the signal distortions.

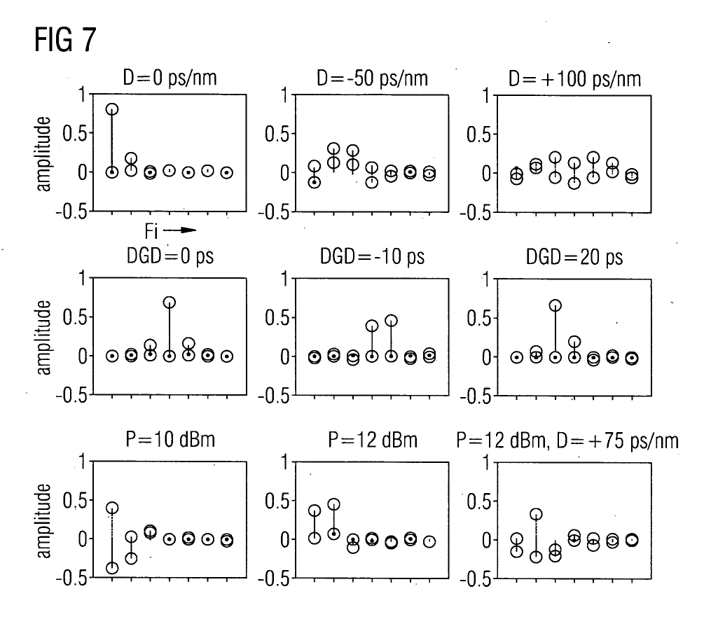

FIG. 7 shows a first adjustment series for the amplitude components, which here are complex, of the seven filter coefficients of a 6^{th} order FIR filter used as an equalizer, for various signal distortions. The upper three diagrams show the amplitude components of the seven filter coefficients for three dispersion values, D=0, −50 and +100 ps/nm. The middle three diagrams show the amplitude components of the seven filter coefficients for three differential group delays, DGD=0, −50 and +20 ps with polarization mode dispersion, PMD. The lower three diagrams show the amplitude components of the seven filter coefficients for two power levels, P=10, 12 dBm and for a power of 12 dBm with a dispersion value D of +75 ps/nm. It can be clearly seen that the filter coefficients differ depending on the type of distortion and its magnitude. This is why it is possible to determine the type of distortion from the filter coefficients.

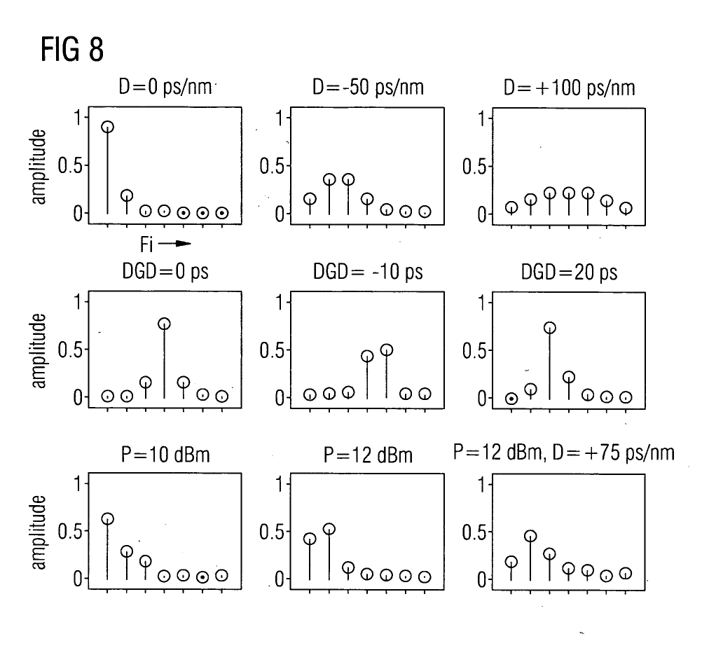

FIG. 8 shows a second adjustment series, in this case of the magnitudes of the complex amplitude components of the seven filter coefficients of a 6^{th} order FIR filter used as an equalizer, for various signal distortions as in FIG. 7. Here, the advantage over FIG. 7 is the halving of the number of coefficients to be considered in determining the distortions, but at the expense or danger that the determination is not made precisely enough.

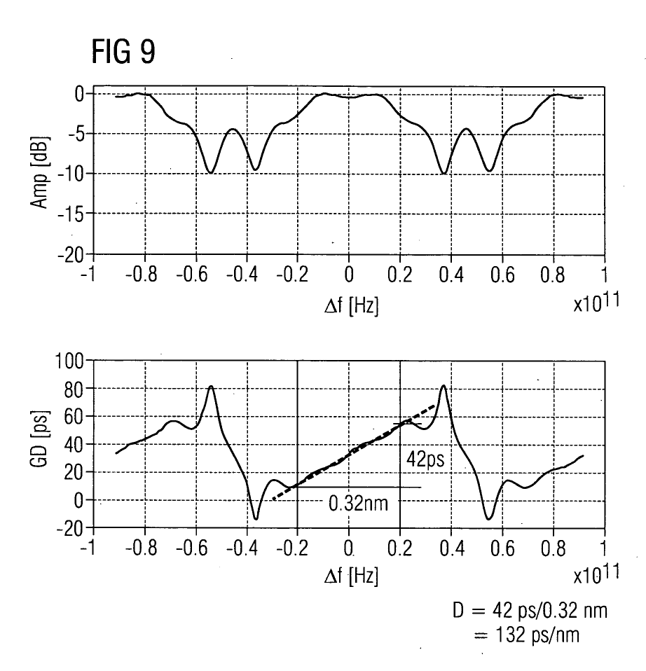

FIG. 9 shows a further possible application of the invention, which consists in calculating and characterizing the transfer function of the transmission link used for the optical signal S, from the adjustment coefficients which have been set to effect equalization using, for example, a compensator provided as a filter. Starting from an amplitude response Amp (above) and a phase response GD (below) for the transmission function of the 6^{th} order optical FIR filter used here—and because the transmission function of this—filter, in the ideal case, the inverse of the transmission function of the transmission link for the optical signal S—a precise analysis of the transmission function of the filter allows conclusions to be reached about the causes of interference to the optical signal on the transmission link. Thus, for example, a linear interpolation can be made for the phase response or the group delay GD (in ps, in the lower part of FIG. 9) of the transmission function in the region of relative frequencies Δf which are of importance for the transmission, approx. ± transmission rate/2 about the central frequency for the filter, and its slope—in this case D=132 ps/nm—and the deviations from this straight line can be used as a basis for characterization. Thus, for example, the dispersion is expressed by a group delay GD which is linear against the frequency, with the slope giving both the sign and the value of the dispersion.

1-39. (canceled)

40. An arrangement for measuring signal degradations for an optical broadband signal transmitted over a transmission system, the arrangement comprising:
a coupler and an adaptive optical filter, wherein from the signal at least an amplitude fraction is tapped off by the coupler and is fed to the adaptive optical filter; and
a first circulator, a bandpass filter, and a second circulator arranged between the coupler and the adaptive optical filter, wherein
an optical signal feedback is connected to the output of the adaptive optical filter for transmitting the filtered signal to the second circulator, wherein
the filtered signal is supplied to a signal quality measurement unit via the second circulator, the bandpass filter, and the first circulator, and wherein
a control unit is connected to the adaptive optical filter for switching through and for influencing signal distortions of the optical signal.

41. The arrangement in accordance with claim 40, wherein an amplifier is interposed between the bandpass filter and the second circulator, or an amplifier is arranged in the optical signal feedback.

42. The arrangement in accordance with claim 41, wherein an amplifier is interposed between the coupler and the first circulator.

43. The arrangement in accordance with claim 40, wherein a unit for the determination of one or more quality parameters is connected to the measurement unit.

44. The arrangement in accordance with claim 40, wherein a bidirectional communication facility is interposed between the determination unit and the control unit.

45. The arrangement in accordance with claim 40, wherein a module for analyzing and separating signal degradations is connected to the determination unit.

46. The arrangement in accordance with claim 40, wherein an opto-electrical converter is arranged upstream of the measurement unit.

47. The arrangement in accordance with claim 40, wherein the adaptive optical filter has a module for influencing the phase and/or amplitude response of the optical signal, and which is controlled by the control unit.

48. The arrangement in accordance with claim 40, wherein the optical signal is a multiplex signal with several optical channels, and the bandpass filters are adjustable channel selection filters.

49. A method for determining signal degradations for an optical signal transmitted in a transmission system, the method comprising:
feeding at least a fraction of the optical signal to an adjustable equalizer at a point in the transmission system;
setting a first series of adjustment parameters of the equalizer;
setting at least one further series of adjustment parameters of the equalizer;
performing an analysis of the first and further series of adjustment with regard to the signal quality of the resulting equalized signals; and
determining from the analysis at least one signal degradation for the optical signal.

50. The method in accordance with claim 49, wherein the optical signal is subject to an opto-electrical conversion and is electrically equalized.

51. The method in accordance with claim 50, wherein the optical signal is equalized by using an IIR filter, or FIR filter, or a compensator for one or more signal degradations.

52. The method in accordance with claim 49, wherein the equalization is effected optically.

53. The method in accordance with claim 52, wherein the optically equalization is effected by using an IIR filter, or FIR filter, or a compensator for one or more signal degradations.

54. The method in accordance with claim 49, wherein the series of adjustment parameters are chosen in a predefined way and are then analyzed together with the resulting signal qualities.

55. The method in accordance with claim 49, wherein for the equalization, the series of adjustment parameters are chosen for optimization of the signal quality.

56. The method in accordance with claim 49, wherein the series of adjustment parameters are chosen according to known causes of signal degradations.

57. The method in accordance with claim 49, wherein the series of adjustment parameters are tabulated and are assigned to one or more types and strengths of signal degradation.

58. The method in accordance with claim 57, wherein further signal degradations are determined from interpolation of the signal degradations assigned to the series of adjustment parameters.

59. The method in accordance with claim 49, wherein one or more optical equalizers or adaptive filters are used, some connected in series and/or some in parallel with one or more electrical equalizers or adaptive filters.
